(19) United States
(12) Patent Application Publication
(10) Pub. No.: US 2012/0263842 A1
(43) Pub. Date: Oct. 18, 2012

(54) COMPOSITION FOR COATING FOODSTUFFS, METHOD FOR MANUFACTURING A COATING AND METHOD FOR COATING FOODSTUFFS

(75) Inventor: Alain Tanguy, Chateaugiron (FR)

(73) Assignee: SONJAL, Brie (FR)

(21) Appl. No.: 13/085,043

(22) Filed: Apr. 12, 2011

(51) Int. Cl. A23L 1/05; A23P 1/08; A23L 1/0534; A23L 1/0532; A23L 1/0522

(52) U.S. Cl. 426/305; 426/575; 426/540; 426/532; 426/490

(57) ABSTRACT

A water-based composition for coating foodstuffs where the composition consists essentially of water as a major component, between about 2 and about 5 w/w % alginate, between about 1 and about 2.5 w/w % starch and between about 0.6 and about 1.3 w/w % carboxymethyl cellulose.

### FIELD OF THE INVENTION

The field of the invention is that of agri-food systems and, in particular, the processing of meat and fish in the form of sausages.

More specifically, the invention relates to a composition for coating a foodstuff, or a food preparation, which makes it possible, in particular, to form an edible vegetable casing, and to a corresponding method for coating a foodstuff.

The invention can be applied in particular in the production of sausages based on pork, lamb, mutton, beef, veal, poultry and/or fish. It can also be implemented to produce sausages prepared from vegetables, fruits and/or cheese.

It can also be implemented to coat the base of a vegetable or a cut edge of a vegetable and to preserve its freshness.

Casings, or skins, which are primarily based on vegetable matter and are also called commonly vegetable food casings when they are tubular in shape, are currently widely used in the agri-food industry.

Food casings of vegetable origin are thus very widely used in order to coat the filling or dough of a sausage owing, in particular, to their advantageous cost compared to casings of animal origin, and owing to the possibility they afford for production on an industrial scale of sausages of standardised size.

Peelable vegetable casings for dry sausage or raw sausage, such as salami, are known.

For example U.S. Pat. No. 5,928,737 proposes to provide a peelable casing from a slightly hydrated paste made with starch and alginate.

It is also common for peelable casings of a known type to contain cellulose fibres.

However, these thick peelable casings, which cannot be digested easily, are not intended for consumption with the filling of the sausage.

Thin (i.e. generally less than 100 micrometres thick) edible casings of primarily vegetable origin are also known, which are used, for example, as a casing for cooked sausages produced on an industrial scale.

These edible casings are usually obtained from an aqueous composition based on alginate provided, in particular, in the form of a paste which is applied directly to the foodstuff to be coated, for example by dipping the foodstuff in the composition, by spraying the composition over the surface of the foodstuff, or by co-extruding the composition around the foodstuff to be coated.

In accordance with another known technique, an edible casing can be formed by extrusion in order to fill it with a food dough.

It has been suggested to incorporate collagen into the composition of edible casings in order to provide them with an acceptable resistance to stretching and/or in order to increase the viscosity of the composition based on alginate with the aim of being able to form these casings by extrusion or by co-extrusion.

A drawback of collagen is that it is primarily extracted from animal bones, fish bones or animal skin. It is not therefore suitable for the production of casings for vegetarian, halal or kosher food products.

A further drawback of collagen is that its use is likely to pose health risks to the consumer by enabling the transmission of diseases, such as the Creutzfeldt-Jakob syndrome.

In addition, it is noted that a casing produced on the basis of collagen has proven to be fragile. It is therefore necessary to proceed with chemical post-treatment in order to reinforce it, for example by using aldehydes in the form of liquid smoke, which significantly modifies the taste of the food product consumed with its casing.

For these reasons, it has been sought to produce edible casings exclusively from vegetable matter.

It has thus been conceived to incorporate galactomannans, such as guar gum, and/or cellulose derivatives into the casing composition to act as a thickening agent, and/or to reinforce and stabilise the casing over time. For example, compositions based on alginate and galactomannans, or based on alginate and cellulose derivatives are known from EP-A-1311165.

A drawback of galactomannans is that they provide the casing with a smooth texture and a shiny appearance, which are unnatural, thus giving the impression of a plastic material. Based on a visual examination, a consumer in search of a quality product is therefore likely to be deterred from buying or eating a food product of which the casing contains galactomannans, irrespective of the quality of this product.

It is also known that the addition of cellulose derivatives with a view to thickening a coating composition does not alone make it possible to provide the casing with sufficient flexibility enabling the avoidance of tearing of the casing during its production or during cooking.

US-2009/0317522 thus proposes using a mixture of cellulose and starch to adapt the rheology, and in particular to thicken a paste based on alginate which is to be applied by co-extrusion around the filling of a sausage.

### SUMMARY

One aspect of the invention is therefore, in particular, to overcome the above-mentioned drawbacks of the prior art.

More specifically, an objective of the invention is to provide a composition and corresponding method for coating a foodstuff which satisfies the quality criteria currently required by the majority of consumers.

In particular an objective of the invention is to provide a composition which gives the coating a texture and appearance which are similar to that of a conventional casing of animal origin.

An aspect of the invention also intends to provide a composition which limits the exudation of liquid by the foodstuff (i.e. syneresis) and makes it possible to keep the appearance and feel of the casing's surface as dry as possible.

A further objective of the invention is to provide a composition which does not change the taste of the coated foodstuff, moreover without posing any danger to the consumer.

An aspect of the invention also also intends to provide a composition which makes it possible to obtain a coating which exhibits a suitable mechanical resistance and a suitable elasticity.

A further aspect of the invention further further intends to provide a composition which makes it possible to obtain a coating which is stable over time, at least over a number of days.

### DETAILED DESCRIPTION

When searching for a water-based composition for coating a foodstuff, said composition comprising water as a major component, and making it possible to achieve these objectives, the applicant surprisingly and unexpectedly found that by combining mainly alginate, starch and cellulose gum with water in specific and previously unreported proportions, it was possible to obtain a substantially white casing, with a matte and opaque appearance, a texture, elasticity and mechanical resistance that are similar to those of an animal casing.

To this end an aspect of the invention relates to a composition comprising between about 2 and about 5% wet weight of alginate, between about 1 and about 2.5% wet weight of starch, and between about 0.6 and about 1.3% wet weight of carboxymethyl cellulose.

The alginate may be sodium alginate, or any suitable type of alginate or mixture of alginates of a known type.

As a result of an aspect of the invention a composition is obtained, in the form of a coating paste, which advantageously combines an appearance which is close to that of a natural animal casing with rheological properties which make it able to be applied around the foodstuff in an optimal manner by co-extrusion, by spray coating or by dipping. In particular most compositions have an apparent viscosity between 40 and 70 Pa·s and they can advantageously be used to produce sausage casings by co-extrusion using existing co-extrusion equipment without having to make substantial changes to this equipment. By carrying out simple routine tests, the person skilled in the art will be able to adapt the respective dosage of alginate, starch and carboxymethyl cellulose of the composition according to the invention suitable for the co-extrusion equipment available to him in order to ensure a constant flow and pressure at the co-extrusion nozzle.

In addition it is noted that the casing obtained after gelification of the coating has a level of bonding suitable for the foodstuff and remains stable over a number of days or weeks, even though it is formed largely of water. Furthermore, it is noted that the casing obtained does not split if it is subjected to a treatment in an acid bath and to cooking, for example when the food preparation and its casing are cooked in the oven, boiled or fried.

The applicant has further noted a very sensitive and unusual limitation of syneresis at the surface of the casing, which it had not been observed previously for compositions based on alginates and galactomannans for example.

In accordance with a possible hypothesis and not being bound to any theory, this combination of coating qualities could be explained, at least in part, by a particularly effective synergy between the alginate and starch in the proportions disclosed herein, this synergy being associated with a weak action of the carboxymethyl cellulose, also known as cellulose gum, over the chemical bonds formed between the alginate and the starch.

It should be noted that, within the scope of the invention, the expression ‘water as a major component’ is understood to mean compositions comprising at least 85% water, preferably at least 90% water and more preferably at least 92% water.

In at least one advantageous embodiment of the invention, such a composition comprises between about 4 and about 5% wet weight of alginate, between about 1.2 and about 1.8% wet weight of starch, and between about 0.9 and about 1.2% by weight of carboxymethyl cellulose.

The mass ratio of starch to alginate in said composition is preferably between 0.2 and 0.45.

The applicant has in fact discovered, unexpectedly, that a particularly effective synergy between the starch and alginate is produced within this mass ratio range, in particular in terms of the texture and elasticity of the composition obtained.

The mass ratio of carboxymethyl cellulose to starch in said composition is advantageously between 0.4 and 0.8.

A composition is thus obtained which exhibits both elasticity and viscosity which are suitable, in particular, for an application by co-extrusion.

Said alginate is advantageously arranged in such a manner that an aqueous solution including about 1% by weight of said alginate has a viscosity between 0.3 and 0.5 Pa·s at 20° C.

By favouring alginates of low viscosity it is then possible to precisely adjust the viscosity of the composition by an appropriate dosage of the amounts of starch and cellulose gum.

In accordance with a particularly advantageous embodiment of the invention, said starch is a starch which is soluble when cold, preferably modified potato starch which is soluble when cold.

It is thus possible to obtain, by simple mixing, a substantially homogeneous composition which is free from agglomerates or lumps of starch owing to the solubility of the cold water soluble starch in water at ambient temperature. It is not therefore necessary to heat the composition in order to dissolve the starches contained, which makes it possible to make savings in terms of energy and time.

It should also be noted that, in a manner known per se, the cellulose gum which is also included in the composition according to the invention is advantageously a cold water soluble additive.

Said water advantageously has a hardness less than 2 ppm (2 mg/L CaCO₃), preferably less than or equal to 1 ppm (1 mg/L CaCO₃).

The level of calcium is therefore controlled and consequently so is the gelification of alginates. The composition can consequently be implemented on a co-extrusion machine with no risk of solidifying or blocking the extruder through which it flows, for example in the case of a temporary stopping or breakdown of the machine. It is only when the coated foodstuff is immersed, after co-extrusion, in a gelification bath or fixing bath containing calcium salts in which the alginate gels that the coating becomes a solid casing.

In at least one embodiment of the invention a composition as described above comprises an acidifying compound belonging to the group comprising at least lactic acid, citric acid, acetic acid or a mixture of at least two of said acids.

The stability of the casing over time is thus improved.

The pH of said composition is preferably between 3.8 and 4.2.

By thus controlling the pH of the composition, the charge density of polysaccharides present in the composition, such as starch and cellulose gum, is reduced.

The gelification of the alginate is consequently not affected by the presence of polysaccharides in the composition. In addition, the viscosity of the composition obtained makes it possible to co-extrude the composition around the foodstuff using conventional co-extrusion equipment.

In accordance with a specific aspect of the invention, the composition comprises a vegetable protein weight which is lower than the alginate weight in said composition.

The addition of vegetable proteins in the composition makes it possible, in particular, to improve the coagulation of the coating upon contact with a calcic bath, thus leading to retraction of the casing together with that of the filling during cooking of the coated foodstuff. The presence of vegetable proteins in the composition also makes it possible, in some cases, to make the appearance of the coated foodstuff more attractive, in particular in terms of colour.

The vegetable proteins present in the composition can be selected, for example, from gluten proteins, pea proteins, soya proteins and mixtures thereof.

It should also be noted that by limiting the amount of vegetable proteins in the composition so as to keep it below the amount of alginate, the total amount of gelifying agents in the composition is restricted. The risk of wrinkling and tearing of the coating is therefore avoided. In other words the addition of vegetable proteins in proportions lower than that of the alginate improves the adherence of the coating without significantly affecting its rheological properties, and in particular its viscosity and the performance of the gel.

Furthermore, it is not necessary to proceed with an additional treatment of the casing in order to ensure its performance for several days.

In at least one embodiment of the invention, the composition optionally comprises at least one compound belonging to the group comprising at least:

food colouring agents, preferably cochineal carmine and/or paprika oleoresin;

food preservatives, preferably potassium sorbate and/or sodium benzoate;

food flavourings, in particular liquid smoke;

visual and/or taste marking agents, preferably spice particles in the form of a powder of suitable granulometry, said particles enabling co-extrusion of said composition around said foodstuff.

The percentage by weight of this or these additional compound(s) is preferably less than 0.5% wet weight of the composition, and even more preferably less than 0.2% wet weight of the composition.

It is thus possible to provide the end food product with a considerable variety of colours and tastes as well as a suitable storage period.

In addition, in compositions in which fine particles of milled spices, for example pepper particles, are incorporated the composition is advantageously filtered in order to prevent these particles from blocking the nozzle of a co-extruder.

The marking agents can be formed from any suitable known coloured food powder which is noticeable or neutral in terms of taste.

The invention also relates to a method for manufacturing a water-based composition for coating foodstuffs comprising a step of filtering the composition through a filter with a mesh size lower than or equal to 120 micrometers.

In at least one embodiment of the invention, said filter mesh size is about 80, 100, 110 or 120 micrometres.

Impurities or clusters of alginate are filtered, thereby allowing the injection of the composition continuously, and with a constant flow into a co-extruder die of a known type, whose spacing is generally between 30 and 200 micrometers, and most often between 80 and 120 micrometers, avoiding the cloging of the die and the stop of the production.

This fine filtration step may advantageously be implemented for the preparation of a composition which can be used to form an edible casing comprising such ingredients as collagen, galactomannans, cellulose derivatives and/or monocrystalline cellulose or any other protein, polysaccharide, sugar, and/or suitable hydrocolloid.

An aspect of the invention also relates to a method for coating a foodstuff with an edible vegetable casing.

According to the invention such a coating method comprises the following steps:

obtaining a water-based composition such as any one of the compositions described above;

immersing a substantial part of said foodstuff in the composition, spray coating said composition around a substantial part of said foodstuff, or co-extrusion of said composition around said foodstuff so as to coat said foodstuff;

bringing the coated foodstuff into contact with a gelling agent, in order to gel the coating.

In particular, the gelling agent may be present in the form of a calcic solution into which the coated foodstuff is dipped, or which is sprayed onto the coating.

In at least one embodiment of the invention, the coating method comprises filtering the composition through a filter with a mesh size smaller than or equal to 120 micrometers.

This filtration step can for example be implemented before putting the composition into the co-extrusion line, or at the inlet of the co-extrusion nozzle.

Further characteristics and advantages of the invention will become clearer upon reading the non-limiting practical examples given by way of simple illustration.

### Preparation of a Composition—Example 1

40 g of lactic acid and 5000 g of softened water of hardness less than 1 ppm are introduced into a tank of a cutter with a maximum capacity of 15 litres. Once the cutter is started, 450 g of sodium alginate powder, 180 g of modified potato starch powder which is soluble when cold, 110 g of carboxymethyl cellulose powder, and 10 g of potassium sorbate granules are added progressively. As soon as the powders and the granules are partially hydrated, 4210 g of additional softened water is added to the composition and the composition is mixed and sheared at high speed for 6 minutes until 10 kilograms of a homogeneous paste is obtained in which the powders and granules are completely hydrated.

This paste has a pH equal to 4, an apparent viscosity of 62 Pa·s at a temperature of 20° C. (measured using a TA Instruments AR 2000 rheometer in a stainless steel plan-cone geometry with 1° of angle and 6 cm of diameter, 180±20 rpm) and a sugar content of approximately 6 degrees Brix.

The alginate used to prepare this composition has a pH of 6.8 and a viscosity of 0.35 Pa·s at 20° C. (measured using a Brookfield viscometer model RV spindle n °1, 20 rpm) when it is diluted to 1% in softened water.

The paste is avantageously pumped through an 80 micron mesh filter, making it possible to remove impurities, and is packaged in a plastic container. A sheet of plastic protection is placed over the surface of the paste and the container is stored in a cold chamber kept between 0 and 8° C., in which the paste can be preserved for 8 months.

In a variant embodiment of Example 1, 20 g atomized black pepper powder with a particle size below 50 microns are substituted for 20 g of softened water in the composition.

### Preparation of a Composition—Example 2

This second composition comprises 9270 g of softened water, 430 g of sodium alginate, 160 g of modified maize starch which is soluble when cold, 125 g of cellulose gum, 10 g of sodium benzoate and 5 g of cochineal carmine for colouration.

No acidifying agent is added to the composition.

This composition has a viscosity of 70 Pa·s at 20° C. and a pH of 4.2. It has proven to be less elastic than that of Example 1.

### Preparation of a Composition—Example 3

This third composition combines each of the compounds of Example 2 in the same proportions except for cellulose gum, of which the mass is reduced to 80 g, and the total mass of softened water (9275 g). Furthermore, 40 g of citric acid are incorporated into this third composition.

This composition has a pH of 4 and a reduced apparent viscosity equal to 43 Pa·s at a temperature of 20° C.

### Example 4 of Preparation of a Composition

This fourth composition comprises 9205 g of softened water, 450 g of sodium alginate, 150 g of modified maize starch which is soluble when cold, 90 g of cellulose gum, 10 g of potassium sorbate, 35 g of lactic acid and 60 g of soya protein.

After gelification these four compositions have an opaque, matte and whitish appearance, and a texture which are close to those of an animal casing.

In the variant embodiment of example 1, there is preferably a homogeneous distribution of marking pepper particles on the surface of the casing, allowing to detect at first glance that it is a pepper sausage. Consequently, the rate of pepper in the dough, and therefore in the end product, may be substantially reduced.

Mechanical tests carried out on gelified casings obtained from these compositions have confirmed that the elasticity and resistance to stretching of the casings is satisfactory. They also make it possible to form casings for sausages, for example Knackwurst sausages, by an extrusion process.

After gelification it is noted by visual examination and by touch that syneresis is the least pronounced in the composition of Example 1.

It is also observed that the compositions of examples 1 and 4 have proven to be the most stable over time.

The paste prepared in accordance with Example 1 has been used to form casings for sausages produced continuously by a co-extrusion method.

To this end the production line of sausages is equipped with a co-extruder and a stuffer directing the sausage dough in the direction of the co-extruder, produced and sold by MAREL. It is noted that the value of the viscosity of the paste of Example 1 is advantageously set at 62 Pa·s by adjusting the dosages of starch and cellulose gum in order to ensure a constant flow of 30 kg/h and a constant pressure between about 4 and about 5 bars at the inlet to the nozzle of the co-extruder.

For this production the sausage dough is formed, in particular, of pork belly and pork fat, sodium nitrite, calcium acetate, sodium lactate or potassium lactate, and spices such as pepper.

At the outlet of the co-extrusion head, the continuous tube of sausage is continuously sprayed with a gelling solution.

The gelling solution is formed of tap water and calcium chloride solubilised in a proportion of 25% of the total weight of the solution.

Upon contact with the gelling solution, the alginate forms a calcium alginate gel, thus forming a resistant casing.

The sausage tube then enters the jaws of a crimper, which jaws, by a rotating movement, cut the tube into 10 centimetre portions and pinch the ends of the casing of each portion, so as to enclose the dough inside the casing.

The casing of these sausages maintains a satisfactory shape, in particular it does not split or rip, and its ends do not burst or allow the filling to escape when the sausages are boiled, cooked, fried or pasteurized.

Furthermore, these sausages demonstrate performance under cooking, assessed by measuring the weight of the sausage after cooking, which is from 5 to 10% greater than that of an identical sausage comprising a natural animal casing.

It should be noted that, by lowering the proportion of cellulose gum in the composition under about 0.8% w/w whilst maintaining a mass ratio of cellulose to starch between about 0.4 and about 0.8, it is possible to obtain a coating paste having, in addition to a suitable elasticity, a viscosity which is sufficiently low to distribute said paste over the surface of a foodstuff by spraying, or else by dipping whilst maintaining a substantially constant thickness.

For example (Example 5) a casing formed from a paste incorporating 9400 g softened water, 40 g of lactic acid, 350 g of sodium alginate, 120 g modified potato starch soluble when cold (i.e. a mass ratio of starch to alginate equal to 0.34), 80 g of cellulose gum (i.e. a mass ratio of carboxymethyl to starch equal to 0.67), and 10 g of potassium sorbate was tested.

The appearance of the casing of Example 5 is satisfactory, but the strength of this casing is low and it also deteriorates significantly after two days. The casing of Example 5 has a viscosity below 40 Pa·s suitable for application by dipping or spraying.

However, it is unsuitable for application by coextrusion. Indeed, the low viscosity composition can flow into the channels of the stuffer's vacuum pump, and into the co-extrusion head, which is not maintained under pressure when production stops.

1. A water-based composition for coating foodstuffs consisting essentially of water as a major component, between about 2 and about 5 w/w % alginate, between about 1 and about 2.5 w/w % starch and between about 0.6 and about 1.3 w/w % carboxymethyl cellulose.

2. The composition according to claim 1, which comprises between about 4 and about 5 w/w % alginate, between about 1.2 and about 1.8 w/w % starch and between about 0.9 and about 1.2 w/w % starch.

3. The composition according to claim 1, wherein the mass ratio of starch to alginate is between about 0.2 and about 0.45.

4. The composition according to claim 3, wherein the mass ratio of carboxymethyl cellulose to starch is between about 0.4 and about 0.8.

5. The composition according to claim 1, wherein the mass ratio of carboxymethyl cellulose to starch is between about 0.4 and about 0.8.

6. The composition according to claim 1, wherein an aqueus solution comprising about 1 w/w % of the alginate has a viscosity of 0.3-0.5 Pa·s at a temperature of 20° C.

7. The composition according to claim 1, wherein the starch is soluble when cold.

8. The composition according to claim 7, wherein the starch comprises modified potato starch.

9. The composition according to claim 1, wherein the water hardness is lower than about 2 ppm.

10. The composition according to claim 9, wherein the water hardness is lower than about 1 ppm.

11. The composition according to claim 1 and further comprising an acidifying compound selected from the group consisting of at least lactic acid, citric acid, acetic acid or a mix of at least two of said acids.

12. The composition according to claim 1, wherein the pH of the composition is between about 3.8 and about 4.2.

13. The composition according to claim 1, and further comprising a mass percentage of vegetable protein lower than that of the alginate in the composition.

14. The composition according to claim 1 comprising at least a compound chosen from the group comprising:
Food coloring agents, including cochineal carmine and/or oleoresin paprika;
Food preservatives, including potassium sorbate and/or sodium benzoate;
Food flavors, including liquid smoke;
Visual and/or taste marking agents, including spice powder particles with suitable particle size, capable of allowing a co-extrusion of said composition around said foodstuff.

15. A method for manufacturing a water-based composition according to claim 1 comprising a step of filtering the composition through a filter with a mesh size smaller than 120 micrometers.

16. The method for manufacturing a water-based composition according to claim 15 wherein the filter mesh size is about 80 micrometers.

17. The method for manufacturing a water-based composition according to claim 15 wherein the filter mesh size is about 100 micrometers.

18. The method for manufacturing a water-based composition according to claim 15 wherein the filter mesh size is about 110 micrometers.

19. A method for coating a foodstuff with an edible vegetal casing comprising the steps of:
obtaining a water-based composition according to claim 1;
immersing a substantial part of the foodstuff in the composition, or, spray coating the composition around a substantial part of the foodstuff, or co-extrusion of the composition around a substantial part of the foodstuff, so as to coat the foodstuff; and
bringing the coated foodstuff into contact with a gelling agent, in order to gel the coating.

20. The method for coating a foodstuff according to claim 19 comprising filtering the composition through a filter with a mesh size smaller than 120 micrometers prior putting or when the composition is into a co-extrusion line.
